(19) United States
(12) Patent Application Publication
(10) Pub. No.: US 2019/0080267 A1
(43) Pub. Date: Mar. 14, 2019

(54) Expert Driven Iterative Method and System to Facilitate Business Valuations

(71) Applicant: John O'Brien, Chatham, NJ (US)

(72) Inventor: John O'Brien, Chatham, NJ (US)

(21) Appl. No.: 15/732,046

(22) Filed: Sep. 8, 2017

(51) Int. Cl. G06Q 10/06; G06Q 40/06; G06K 9/62

(52) U.S. Cl. CPC G06Q 10/067; G06K 9/6218; G06Q 40/06

(57) ABSTRACT

A method and system of facilitating business valuations by using a mix of expert assistance, cluster analysis, financial modeling, and computer technology. This is approach accommodates companies seeking additional capitalization, includes valuing intangible assets, and integrates current data from competitors and current information which may have an impact to the firm under evaluation. This approach can be periodically updated in a relatively easy manner.

The present invention was first filed as a provisional patent application on Sep. 11, 2016. This utility filing incorporates the material and prior date of that filing.

### FIELD OF THE INVENTION

The present invention relates to business valuation methods and systems for determining the value of a business, especially companies seeking additional capitalization, and more specifically to the use of expert driven assistance to the method based on financial modeling techniques and cluster analysis.

### REFERENCES CITED

The following references are cited.

| | | | |
|---|---|---|---|
| 20020174081 | November 2002 | Charbonneau | 706/15 |
| 20040133439 | July 2004 | Noetzold | 705/35 |
| 20040128174 | July 2004 | Feldman | 705/007 |
| 20050071174 | March 2005 | Leibowitz | 705/35 |
| 20050234733 | October 2005 | Leitner | 705/1.1 |
| 7,693,733 B2 | June 2010 | Edler | 705/7 |
| 7,778,936 | August 2010 | Adhikari | 705/76 |
| 7,979,332 | July 2011 | Tombs | 705/36R |
| 20120310844 | December 2012 | Carter | 705/306 |
| 20120310685 | December 2012 | Carter | 705/7.11 |
| 20120310806 | December 2012 | Carter | 705/35 |
| 20120310798 | December 2012 | Carter | 705/30 |
| 20130132192 | May 2013 | Krukowski; | 705/14.51 |
| 20130173342 | July 2013 | Bills | 705/7.31 |
| 8,645,253 | February 2014 | Krull | 705/36R |
| 20160110672 | April 2016 | Carter | 705/7.39 |

“International Valuation Standards 2011”; International Valuation Standards Council; 41 Moorgate, LONDON, EC2R 6PP, United Kingdom, Tel: +44 (0)20 7374 5585 Email: ivsc@ivsc.org ISBN: 978-0-9569313-0-6
Ulyana Dzyuma “Real Options Compared to Traditional Company Valuation Methods: Possibilities and Constraints in their Use”; Financial Internet Quarterly “e-Finanse” 2012, vol. 8, nr 2; www.e-finanse.com; University of Information Technology and Management, Sucharskiego 2, 35 225 Rzeszow
“A market for ideas” Economist Oct. 20, 2005

### BACKGROUND OF THE INVENTION AND DISCUSSION OF PRIOR ART

Investors, as well as company owners, have long suffered with the problem of how to arrive at a usable valuation of a private company. This is particularly true when a company or firm is seeking additional capitalization. There are many teachings of different approaches to arrive at a valuations. Most of these teachings involve projecting or interpolating, or statistically inferring how current results may be projected to future results. This approach is a “more of the same” type of projection, and these approaches assume that the future for the firm will be much like the past. This is a solid technique for a funeral home located in a population stable homogenous community—where everyone is up to date on flu shots. This is not a promising technique for a technology, pharmaceuticals, or a firm in a rapidly evolving or growing industry. Still other techniques revolve around interesting approaches which have opinions of value as their centerpiece. Still other approaches detail excessively what information they need to collect, but do not disclose how they weave that gold into value. A quick summary of prior art approaches will help to provide background.

Charbonneau (20020174081) uses neural networks trained to learn nonlinear interpolation relations mapping a company's fundamental financial data to obtain a value. A sophisticated approach to project more of the same.

Krull (U.S. Pat. No. 8,645,253) combines, for one of his preferred embodiments, three main types of financial indicators, specifically an earnings-yield factor, an interest factor and a growth indicator and then uses forward earnings yields associated with the S&P 500 index, a 20-year historical average growth rate, and the interest rate associated with the 10-year US Treasury note/bond as metrics to determine value. A solid shotgun approach to project more of the same.

Adhikari (U.S. Pat. No. 7,778,936), Feldman (20040128174) and Noetzold (20040133439) seem to have devised a valuation approach aimed at valuing larger companies or whole enterprises. Adhikari seems to be focused on companies as they acquire other companies. “In the EBITDA Synergy cell 114, the user enters the anticipated Synergy between the Buyer and the business or the anticipated operating costs changes after the acquisition or merger.” Feldman starts his process by asking the user to input data from its IRS filing, long term and short term debt. This approach is more assess by numbers than in touch with what the company is doing. Noetzold devotes his teachings to environments of larger corporations and subsidiaries and relies upon existing tools to help assign values to the parts. These three approaches do not consider smaller companies and indeed, the word intangible never even appears in two of these three patent applications and in the third is not used in a property sense. In a 2005 article The Economist reported that “As much as three-quarters of the value of publicly traded companies in America comes from intangible assets, up from around 40% in the early 1980s.” This reduces the usefulness of these three approaches.

Carter has a number of similar applications (20120310844), (20120310685), (20120310806), (20120310798), and (20160110672) and teaches an approach to valuation which revolves around the user entering 7 or 8 pages of requested data. Carter also teaches an embodiment using a “melded” approach, in his words:
“ . . . our focus is to try to provide the best approach for small businesses. So, we include a meld of the following:
   . . . Market Approach: This involves analyzing the recent Sales of comparable businesses. In a way, this is similar to how a residential real estate is valued.
   . . . Income Approach: With this, you forecast future Income and then find the present value of these streams.
   . . . Rules-of-Thumb: These are simple valuation methods that are often used by financial advisors.”
      Exactly how things get “melded” or what occurs in the calculations on seven pages of data is never explained by Carter.

Bills (20130173342) Bills teaches a method for valuing innovation and technology. He allows for a wide scope of assignment of score by the individual. He does not teach how those scores might be assigned. Indeed he almost arbitrarily suggests using the Fibonacci Sequence as a score metric without any justification of why. To wit: “The values assigned to each subsegment may increase according to a Fibonacci sequence. Alternatively, values may be assigned according to the user's preference. It will be appreciated that values may be assigned to each parameter using a variety of methods.” Then he uses mathematical techniques to manipulate the scores. This is another example of arbitrary scores then carefully processed.

Leibowitz (20050071174) teaches a very interesting approach to valuing intellectual property. He collects all known relevant data about the property and stores it into a conceptual fingerprint. He does this for all conceivable patents. Then he finds like matches to this fingerprint and then determines the value by
“applying weightings, priorities and/or probabilistic criteria to the valuation model according to criteria related to the transaction under consideration to generate a final valuation model.”
   This sounds like it may be a promising approach, even though the clarity of the plan is elusive. However, it also suffers from a major flaw. Unless a patent has been licensed and is a revenue producer it will not have the data to support a strong fingerprint under this plan. Indeed the majority of patents are not licensed. The approach Leibowitz teaches, then, is strongly coupled to the collection and maintenance of a huge database of fingerprints of licensed patents. Presumably then he determines that his patent to be valued is, close enough. Such an approach also assumes that each patent licensed was licensed individually, not part of a portfolio, and not under duress of a patent infringement claim or argument. Such assumptions do not bear out when compared to the reality of how patents are really licensed.

Tombs (U.S. Pat. No. 7,979,332) teaches a method for valuing a business based when the business is generating an acceptable return to an owner during a defined investment period, tying that to a business capitalization rate and comparing that to the notional business profitability. Many firms will not meet his entry requirements for generating an acceptable—or any—return when they want to capitalize.

Leitner (20050234733) teaches a real time collaborative and averaging technique which obtains a value from multiple analysts, revises and redistributes it to all and repeats to successive rounds of valuation.

Edler U.S. Pat. No. 7,693,733) teaches a comprehensive system of data collection, database storage, processing. Edler teaches breaking down the company valuation into a number of elements which are then valued. In Edler's discussion of background and prior art, he provides an absolutely brilliant and comprehensive discourse on what the issues are with company valuations. This description is so valuable that we will present it below verbatim. In that description Edler mentions the phrase “intangible assets” 17 times highlighting its importance in the valuation. In the Summary Description section Edler alludes to intangible assets as an objective or benefit of his invention 5 times. However, in the Detailed Description Edler only tangentially mentions “intangible” 2 times. It is almost as if one person wrote the background section aware of how important intangible assets are and a second wrote the patent specification without any thought or appreciation of how to actually consider intangible assets.

Expanding the above thought, the concept of an Expert is entirely missing from Edler's patent. Only 3 times does that word appear and each time it is in the title of a reference. References to an appraiser or CPA, occur 13 times—but only in the background section. Throughout the specification the words define, definition, specify, specification occur many times but never as a source of expertise and only in the sense of some providing a value or telling an answer. So Edler's patent centers around a massively great concept which is realized by using existing data collected from various places and then processing that data. There is no call for expertise in judging the adequacy, veracity, applicability, usefulness, or appropriateness of the data used. There are no experts nor any expert roles, and intangible data somehow magically gets accounted for simply because at the beginning of the specification Edler taught that it was very important.

Fifteen paragraphs from Edler's U.S. Pat. No. 7,693,733, form the superb Background and Prior Art section are introduced here verbatim as follows.

“The valuation of a business is a complex and time-consuming undertaking. Business valuations determine the price that a hypothetical buyer would pay for a business under a given set of circumstances. The volume of business valuations being performed each year is increasing significantly. A leading cause of this growth in volume is the increasing use of mergers and acquisitions as vehicles for corporate growth. Business valuations are frequently used in setting the price for a business that is being bought or sold. Another reason for the growth in the volume of business valuations has been their increasing use in areas other than supporting merger and acquisition transactions. For example, business valuations are now being used by financial institutions to determine the amount of credit that should be extended to a company, by courts in determining litigation settlement amounts and by investors in evaluating the performance of company management.

In most cases, a business valuation is completed by an appraiser or a Certified Public Accountant (hereinafter, appraiser) using a combination of judgment, experience and an understanding of generally accepted valuation principles. The two primary types of business valuations that are widely used and accepted are income valuations and asset valuations. Market valuations are also used in some cases but their use is restricted because of the difficulty inherent in trying to compare two different companies.

Income valuations are based on the premise that the current value of a business is a function of the future value that an investor can expect to receive from purchasing all or part of the business. Income valuations are the most widely used type of valuation. They are generally used for valuing businesses that are expected to continue operating for the foreseeable future. In these valuations the expected returns from investing in, the business and the risks associated with receiving the expected returns are evaluated by the appraiser. The appraiser then determines the value whereby a hypothetical buyer would receive a sufficient return on the investment to compensate the buyer for the risk associated with receiving the expected returns. Income valuation methods include the capitalization of earnings method, the discounted future income method, the discounted cash flow method, the economic income method and other formula methods.

Asset valuations consider the business to be a collection of assets which have an intrinsic value to a third party in an asset sale. Asset valuations are typically used for businesses that are ceasing operation and for specific type of businesses such as holding companies and investment companies. Asset valuation methods include the book value method, the adjusted book value method, the economic balance sheet method and the liquidation method.

Market valuations are used to place a value on one business by using valuations that have been established for comparable businesses in either a public stock market or a recent transaction. This method is difficult to use properly because no two companies are exactly the same and no two transactions are completed for the exact same reasons. Market valuation methods include the price to earnings method, the comparable sales method, industry valuation methods and the comparable investment method.

When performing a business valuation, the appraiser is generally free to select the valuation type and method (or some combination of the methods) in determining the business value. Under the current procedures, there is no correct answer, there is only the best possible informed guess for any given business valuation. There are several difficulties inherent in this approach. First, the reliance on informed guessing places a heavy reliance on the knowledge and experience of the appraiser. The recent increase in the need for business valuations has strained the capacity of existing appraisal organizations. As a result, the average experience level of those performing the valuations has decreased. The situation is even worse for many segments of the American economy where experienced appraisers don't exist because the industries are too new. Another drawback of the current procedures for completing a valuation is that the appraiser is typically retained and paid by a party to a proposed transaction. It is difficult in this situation to be certain that the valuation opinion is unbiased and fair. Given the appraiser's wide latitude for selecting the method, the large variability of experience levels in the industry and the high likelihood of appraiser bias, it is not surprising that it is generally very difficult to compare the valuations of two different appraisers—even for the same business. These limitations in turn serve to seriously diminish the usefulness of business valuations to business managers, business owners and financial institutions.

The usefulness of business valuations to business owners and managers is limited for another reason—valuations typically determine only the value of the business as a whole. To provide information that would be useful in improving the business, the valuation would have to furnish supporting detail that would highlight the value of different elements of the business. An operating manager would then be able to use a series of business valuations to identify elements within a business that have been decreasing in value. This information could also be used to identify corrective action programs and to track the progress that these programs have made in increasing business value. This same information could also be used to identify elements that are contributing to an increase in business value. This information could be used to identify elements where increased levels of investment would have a significant favorable impact on the overall health of the business.

Another limitation of the current methodology is that financial statements and accounting records have traditionally provided the basis for most business valuations. Appraisers generally spend a great deal of time extracting, aggregating, verifying and interpreting the information from accounting systems as part of the valuation process. Accounting records do have the advantage of being prepared in a generally unbiased manner using the consistent framework of Generally Accepted Accounting Principles (hereinafter, GAAP). Unfortunately, these accounting statements have proved to be increasingly inadequate for use in evaluating the financial performance of modern companies.

Many have noted that traditional accounting systems are driving information-age managers to make the wrong decisions and the wrong investments. Accounting systems are “wrong” for one simple reason, they track tangible assets while ignoring intangible assets. Intangible assets such as the skills of the workers, intellectual property, business infrastructure, databases, and relationships with customers and suppliers are not measured with current accounting systems. This oversight is critical because in the present economy the success of an enterprise is determined more by its ability to use its intangible assets than by its ability to amass and control the physical ones that are tracked by traditional accounting systems.

The recent experience of several of the most important companies in the U.S. economy, IBM, General Motors and DEC, illustrates the problems that can arise when intangible asset information is omitted from corporate financial statements. All three were showing large profits using current accounting systems while their businesses were falling apart. If they had been forced to take write-offs when the declines in intangible assets were occurring, the problems would have been visible to the market and management would have been forced to act on them much sooner. These deficiencies of traditional accounting systems are particularly noticeable in high technology companies that are highly valued for their intangible assets and their options to enter new markets rather than their tangible assets.

The accounting profession itself recognizes the limitations of traditional accounting systems. A group of senior financial executives, educators and consultants that had been asked to map the future of financial management by the American Institute of Certified Public Accountants (AICPA) recently concluded that: a) Operating managers will continue to lose confidence in traditional financial reporting systems, b) The motto of CFOs in the future will likely be “close enough is good enough”, and c) The traditional financial report will never again be used as the exclusive basis for any business decisions.

The deficiency of traditional accounting systems is also one of the root causes of the short term focus of many American firms. Because traditional accounting methods ignore intangible assets, expenditures that develop a market or expand the capabilities of an organization are generally shown as expenses that only decrease the current period profit. For example, an expenditure for technical training which increases the value of an employee to an enterprise is an expense while an expenditure to refurbish a piece of furniture is capitalized as an asset.

Even when intangible assets have been considered, the limitations in the existing methodology have severely restricted the utility of the valuations that have been produced. All known prior efforts to value intangible assets have been restricted to independent valuations of different types of intangible assets with only limited attempts to measure the actual impact of the asset on the enterprise that owns it. Some of the intangible assets that have been valued separately in this fashion are: brand names, customers and intellectual property. Problems associated with the known methods for valuing intangible assets include: 1. Interaction between intangible assets is ignored, for example the value of a brand name is in part a function of the customers that use the product—the more prestigious the customers, the stronger the brand name. In a similar fashion the stronger the brand name, the more likely it will be that customers will stay a long time. Valuing either of these assets in isolation will give the wrong answer; and, 2. The value of an intangible asset is a function of the benefit that it provides the enterprise. Therefore, measuring the value of an intangible asset requires a method for measuring the actual impact of the asset on the enterprise—something that is missing from known existing methods.

The historical dependence on accounting records for valuing business enterprises has to some extent been a matter of simple convenience. Because corporations are required to maintain financial records for tax purposes, accounting statements are available for virtually every company. At the same time, the high cost of data storage has until recently prevented the more detailed information required for valuing intangibles from being readily available. In a similar manner, the absence of integrated corporate databases within corporations and the home-grown nature of most corporate systems has until recently made it difficult to compare similar data from different firms. Unfortunately, even the firms that have established integrated business management systems find that retrieving the information required to perform an integrated analysis of their data is a cumbersome task. These firms also find that there are few tools that facilitate the analysis of the information after it is gathered together in one place.

The lack of a consistent, well accepted, realistic method for measuring all the elements of business value also prevents some firms from receiving the financing they need to grow. Most banks and lending institutions focus on book value when evaluating the credit worthiness of a business seeking funds. As stated previously, the value of many high technology firms lies primarily in intangible assets and growth options that aren't visible under traditional definitions of accounting book value. As a result, these businesses generally aren't eligible to receive capital from traditional lending sources, even though their financial prospects are generally far superior to those of companies with much higher tangible book values.”

### SUMMARY OF THE INVENTION

It is the object of the present invention to provide a method and system to facilitate company valuations.

It is yet a further object of the present invention to provide a valuation approach which accommodates valuing intangible assets.

It is yet a further object of the present invention to provide a valuation approach which integrates current data from competitors and current information which may have an impact to the firm under evaluation.

It is yet a further object of the present invention to provide a valuation approach which can be periodically updated in a relatively easy manner.

It is yet a further object of the present invention to provide a valuation approach which can be used to value firms seeking additional capitalization.

### BRIEF DESCRIPTION OF THE DRAWINGS

The features and advantages of the present invention will become apparent to those skilled in the art from the following description with reference to the drawings, in which:

FIG. 1 Is a presentation of a computing system block diagram

FIG. 2 Is a presentation of a system block diagram

### DETAILED DESCRIPTION OF THE INVENTION

To better appreciate the present invention, we first discuss some deficiencies with the prior art which we seek to correct. We first note that while not restricting the present invention to be used only for valuations of firms seeking additional capital, it is for firms seeking capital which gave rise to the present invention. We further note that the additional aspects of the present invention specifically included to help value capital seeking firms, will also help improve the valuation of all firms—even those which are not seeking additional capital. In other words, firms that are seeking additional capital are the most difficult and exacting firms for which to provide evaluations.

As might be clear from the discussion in the background section above there are two main faults of commission of the prior art and three main faults of omission. We next discuss these 5 faults.

The first fault and first commission failure is (1) a failure to even recognize or adequately deal with intangible assets. Indeed, the International Valuation Standards Council may be a contributory party to this failure as that organization's Valuation Standards recommends throwing intangible value into “goodwill” if the intangible value is “not separable”. Their definition follows:
“if it either:
(a) is separable, ie capable of being separated or divided from the entity and sold, transferred, licensed, rented or exchanged, either individually or together with a related contract, identifiable asset or liability, regardless of whether the entity intends to do so, or
(b) arises from contractual or other legal rights, regardless of whether those rights are transferable or separable from the entity or from other rights and obligations.”

A simple example highlights the ill-advised nature of this approach. If a firm has an unlicensed technology and or patent, then it is not separable and hence becomes part of the goodwill of that firm according to the International Valuation Standards Council. If, however, the day before the valuation the firm licensed that technology and or patent for a 10 million dollar contract, then that technology generates 10 million dollars of value. This isn't the same as future sales, as the value of the sales organization is extrinsically valued and projected by past numbers and other considerations, but the more intangible value of intellectual property is simply ignored by this approach in toto until a contract occurs.

The second fault and second commission failure is (2) a predisposition to take existing revenue and expense numbers and project them forward in either a simple or ingeniously complex way—the fault being failing to account for different behaviors and influences which would undermine those projections.

Three additional omission complete the list of five faults, briefly alluded to in the previous discussion, but not heavily highlighted, they are:

The first additional omission failure and third fault (3) is the failure to include or consider the competitive firms and the competitive nature of firms active in the same business area as the firm under evaluation. The closest any of the prior art approaches take is including ratio analysis in their financial calculations thereby taking the business ratios of “like firms” and therefore competitors into account in their financial analysis. This, however, does nothing to consider these firms as competitors.

The second additional omission failure and fourth fault (4) is the failure to include expert analysis in the valuation process. Experts are import to evaluate both the authenticity as well as the veracity of the data received from the firm. We note here that experts comprise a wide field of contributors, including, but not limited to, technical experts, financial experts, industry experts, entrepreneurial experts, economic experts, administrative experts, managerial experts, strategy experts, and the like. Experts also contribute by placing this information received from the company into context as to it applicability, weighting, and potential impact on company operations in the future. Experts also perform the same function not only on information about competitors to the firm, but also associated informational areas (“Associated Informational Areas”) including such areas, but not limited to, industry trends and influences, regulatory controls, taxation changes, effect of economic changes, technology trends, social trends, demographic trends, meteorological trends, political trends, entrepreneurial trends, and the like. These Associated Informational Areas might also impact the firm.

The third additional omission failure and fifth fault (5) is the failure to research, collect, organize and include for expert consideration both the competitive information and the Associated Informational Areas discussed above. An aspect of the present invention discusses cluster analysis as a way of collecting data from Associated Informational Areas and this is discussed further below. The contribution of data from the Associated Informational Areas is important as it is largely derived independently of data directly contributed from the firm under evaluation. This allows a needed check and balance from one-sided information regardless of being intentional or not.

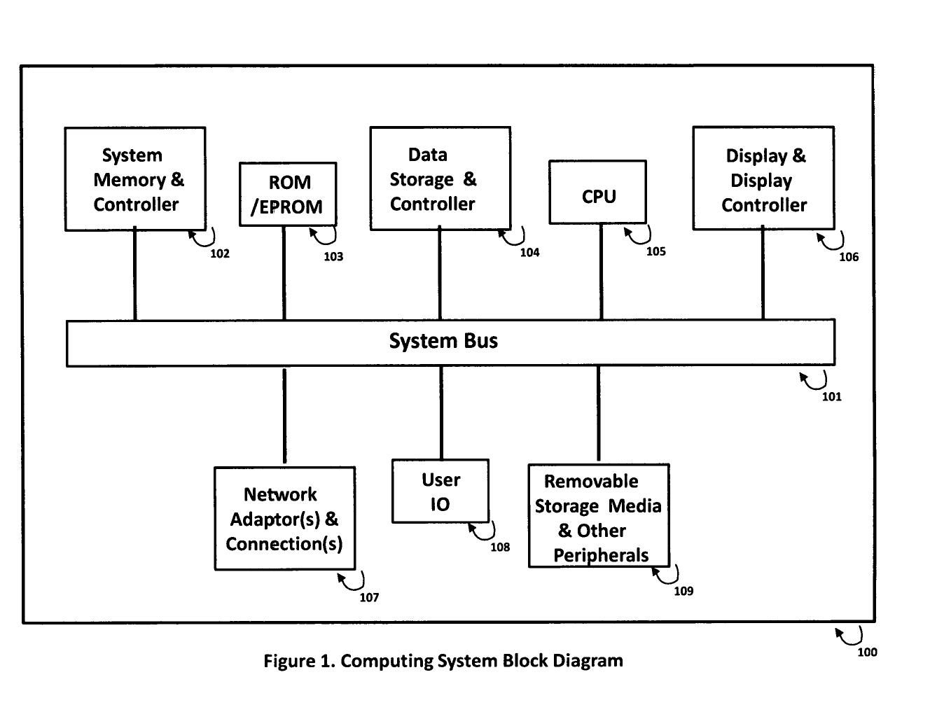

The present disclosure describes a system and method for determining the financial valuation of a company—particularly a company seeking funding. Various embodiments of the systems and methods disclosed here facilitate financial valuations of companies. Embodiments of the present disclosure introduce a framework for gathering and processing information about a company and its environments. The embodiments disclosed herein help partition a company into different segments or dimensions so that the tools of financial analysis can be more accurately applied. This approach ensures intangible properties are valued, and also fosters risk analysis to be included—an aspect often overlooked in valuations. This approach helps to significantly improve valuation accuracy. The following embodiments are performed using a central computer server system having one or more processors executing computer readable instructions corresponding to a computer system shown in FIG. 1 and described below.

FIG. 1 depicts an exemplary computing system 100 for use in accordance with herein described system and methods. Computing system 100 is capable of executing software, such as an operating system (OS) and a variety of other system and application code. The operation of exemplary computing system 100 is controlled primarily by computer readable instructions, such as instructions stored in a computer readable storage medium, some examples of such media being system memory data storage chips 102, Read Only Memory 103, data storage memory chips 104 or hard disk drives 104, removable data storage media such as CDs, DVDs, optical disks, USB storage devices, floppy drives, and other peripheral devices. Such instructions may be executed within the CPU (“CPU”) which serves as the central processing unit 105 and it may be implemented as or more integrated circuits or processor chips—sometimes on the same mother board and sometimes remotely. Some embodiments may involve a plurality of processor chips acting in concert to serve as a CPU. Whatever the form of the CPU, the instructions cause the computing system 100 to perform operations.

In operation, CPU 105 fetches, decodes, and executes instructions from a computer readable storage medium 104. Such instructions can be included in software such as an operating system (OS), executable programs, and the like. Information, such as computer instructions and other computer readable data, is transferred between components of computing system 100 via, for example, the system's data bus 101. The main data-transfer path may use such a system bus architecture 101, although other computer architectures (not depicted here) can be used, such as architectures using serialization and deserialization and crossbar switches to communicate data between devices over serial communication paths.

As those skilled in the art well understand, system memory connected to the system bus 101 may include random access memory 102, memory located at the other end of a serial extension port such as PCIe extended serial bus or equivalent, read only memory (ROM) 133, and erasable programmable read only memory (EPROM) 133. Such memories include circuitry that allows information to be stored and retrieved according to the well understood rules of data access, memory addressing and virtual machine memory.

Computing system 100 may contain various User IO controllers 108 and or peripheral controller 109 responsible for communicating instructions using a peripheral bus from CPU 105 to peripherals and or IO devices. Such devices often support various IO keyboard, mouse, trackpad, joystick, light pen, voice driven, or similar devices. An example of a system bus and or peripheral bus is the Peripheral Component Interconnect (PCI) bus—sometimes used as both in the same computing system.

In addition, computing system 100 also supports a display capability 106 and network adapter 107 which may be used to connect the computing system 100 to an external communication network which may include or provide access to the Internet Communications network.

It is appreciated that the exemplary computing system 100 is merely illustrative of a computing environment. This computing description does not limit the implementation of the herein described systems and methods in the computing environments, constraining them to have differing components and configurations, as the inventive concepts described herein may be implemented in various computing environments using various components and configurations.

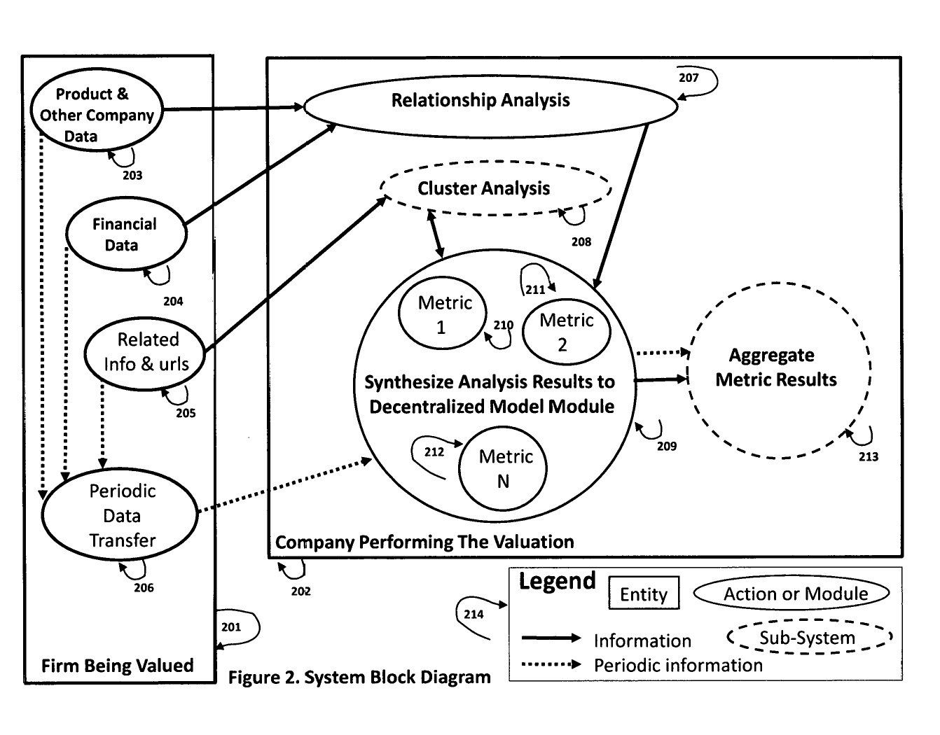

FIG. 2 depicts a system block diagram of the operational actions of a company 202 performing a valuation on a different firm (“Firm”) 201. The company (“Company”) performing the evaluation may be comprised of one or more full time and or part time people and or consultants and it has from all those individuals one or more experts serving in a helping or consulting capacity where the expertise of the people and consultants pertain to the business, type or industry of the Firm 201. The Firm 201 is responsible for providing a variety of information and access to the Company 202, This includes Product and Other Company data 203, Financial data, 204, and Related Information and URLs 205. In addition to this initial supply of data, the Firm 201 also supplies periodic data transfers as updates to the initial data transfer. Periodic may be quarterly or monthly or in extreme cases as depends on the Firm 201 and its agreement with the Company 202.

Product and Other Company data 203 means any product and or service which is currently being offered, by the firm, for sale, lease, rental, or barter, including software in all its various forms and expressions, or likewise any product and or service currently under active development or in active preparation but not yet ready for public release, all product and service client/customer/user documentation and manuals, and all marketing and sales information, competitive information, market intelligence, related case studies, documentation, and data typically supplied to the client/customer/user. This also includes, but is not limited to, all patents and patent rights, patent applications, trademarks, trade secrets, copyrights, customer beta test data, all product and service related data, any and all test data associated with industry group(s) or trade associations or government agency trials or approvals. This also includes, but is not limited to, all sales and marketing related data concerning any products, or services, or licensing, and all sales support materials either typically provided to clients/customers/users or used internally to support clients/customers/users.

Financial data 204 means all existing financial data pertaining to the firm. This would include but not be limited to annual reports, audit information balance sheets, income statements, and tax or SEC filings and the like.

Related Information and URLs 205 means the Finn 201 selects websites/URLs to represent competitors, suppliers, related sites to the Firm's 201 industry.

All of this information supplied by the Firm 201 to the Company 202 is then considered, analyzed, and used by the Company 202 together with additional information gathered by the Company 202 in the Valuation process.

In addition to the initial information transferred to the Company, ie Product and Other Company data 203, Financial data, 204, and Related Information and URLs 205, the Firm 201 also supplies periodic information 206 to the company. This information is of the same form as initially transferred but updated and more current.

The Product and Other Company data 203 and Financial data, 204 are primarily used in the Relationship Analysis 207 conducted by the Company 202. During the Relationship Analysis 207 all the data supplied by the Firm is examined together with any related data about the Finn 201 or its business environment gathered by the Company 202 or its agents. Prior to the analysis the Company 202 must satisfy itself that it has sufficient experts and expertise available either within the Company 202, or as agents or consultants to the Company 202 to perform the evaluation on the target Finn in whatever industry the Finn 201 is associated. The Firm 201 is classified into five different dimensions by the Company.

One of the preferred embodiments of the present invention involves the most complex company valuation case because the less complex cases reduce to subsets of the complex case. It stands to reason the more limited, uniform, and one dimensional the company, the easier valuation. The high complexity case is the firm that is not only complex itself, but that also is trying to raise capital. The act of raising capital indicates there is a future looking occurrence, presumably value generation, and future playing story about the firm. Somehow, the veracity of the circumstance(s), likely success of the forward plan(s), and the likely impact of such stories need to be captured in the company valuation. Not only forward looking value but the associated risk must be considered. All aspects of a complex company value system may be grouped into five different value dimensions (“Dimensions”): (1) Financial Information, (2) People Resources, (3) Company Business Relationships External to the Firm, (4) Offerings, and (5) Intellectual Property.

The inventors expand on these five Dimensions below but we first note four important attributes which apply to this group of Dimensions in aggregate.

First, the group collectively includes all the value of the firm. In other words there is no component of value which may be identified which lies outside the boundaries of these five Dimensions.

Second, each Dimension is mutually exclusive to each other. That is, there is no value component of one group which is also belongs in a second group.

Third, there are interdependencies across the different Dimensions. That is one or more Dimensions may be a co-producer of another. For example, more people and more money could generate more intellectual property. Note that this is not a transfer of value from one Dimension to another, but rather where resources from two different Dimensions cooperate to create added value in a third Dimension. Thus the firm to be evaluated is a high complexity system.

Fourth is an observation that Dimensions 1 & 2 represent tangible entities, while Dimensions 3 through 5 represent intangible assets.

We now discuss the five different Dimensions. An aspect of the present invention is that a “snapshot” of each of the five Dimensions would be gathered at the same approximate time. In other words the five Dimensions need to be evaluated in a close timeframe, not distributed over an extended period of time.

Financial Information. (“Financial Information”) means all existing financial data pertaining to the firm. This would include but not be limited to annual reports, audit information balance sheets, income statements, and tax or SEC filings and the like.

People Resources. (“People Resources”) include, but are not limited to, all people associated with the firm in any kind of service relationship where compensation of any kind is exchanged, including employees, part time employees, consultants under signed contracts, professional advisors, Board Members, etc.

Company Business Relationships External to the Finn. (“Company Business Relationships External to the Firm”) means any contractual or written agreement or memorandum of understanding between the firm and its clients, customers, suppliers, vendors, organized unions, or any other professional agency.

Offerings. “Offerings” means any product and or service which is currently being offered, by the firm, for sale, lease, rental, or barter, including software in all its various forms and expressions, or likewise any product and or service currently under active development, or on hold for some reason, or in active preparation but not yet ready for public release, all product and service client/customer/user documentation and manuals, and all marketing and sales information, documentation, and data typically supplied to the client/customer/user.

Intellectual Property. (“Intellectual Property”) includes, but is not limited to, all patents and patent rights, patent applications, trademarks, trade secrets, copyrights, customer beta test data, all product and service related data not explicitly itemized in the Offerings definition, any and all test data and rights and associated with industry group(s) or trade associations or government agency trials or approvals.

The Relationship Analysis is iterative. It requires a team of one or more analysts of some expertise in the subject matter area of the Firm. These analysts review the submitted data by the Firm 201 discussed above and then define a view of the Firm 201 according to the five Dimensions discussed above, and iterate the analysis as necessary to resolve the definitions.

Implicit in the discussion of these five Dimensions is the reality that each has their own context external to the control of the Firm 201. The Firm 201, for example, has no control over interest rates, or how plentiful the labor pool might be, or a competitor's action or reaction. This context must be considered as part of the valuation. As an additional iterative step, the analysts also consider the results of the Cluster Analysis 208 which is performed on both the Related information & URLs supplied by Firm 201 as well as selected documents, data, and URLs supplied by the analysts team.

Those skilled in the art will recognize that there are many ways to do clustering analysis. One of the preferred embodiments of The Cluster Analysis 208 itself is as follows.

The clustering approach employs the following method. This method is based on first assembling a corpus of documents and url sites associated with the Firm 201 under evaluation and then programmatically examining that corpus to compile a list of themes or cluster words. We note that this clustering analysis may be organized around three different approaches each of which is a preferred embodiment of the present invention.

Method 1 is to simply cluster the entire corpus for themes. Method 1 uses the null search string.

Method 2 accepts serial rounds of search terms submitted by: (i) subject matter experts familiar with the Firm 201 under evaluation, and or (ii) the evaluating company, and or (iii) submitted by the Firm 201 itself. These search terms would contain one or more strings, and then the results of those different searches would yield different subsets of material from the corpus each generated by each serial search. Then a separate list of resulting clusters or themes would be derived from each subset. Note that the different subsets would have partial overlap with each other. This is expected and appreciated as the clustering themes which are related to the different subsets would be different. The objective here is to tease out different ideas, themes, and relationships so that they may be considered as supports of value, of elements of risk to that value.

Method 3 is similar to method 2 except the search strings are pre-compiled ahead of time in different groups where a specific group may represent different disciplines, eg, quality control or strategy etc., or different industries, eg pharmaceuticals, or computer technology etc., or other differentiating areas.

Each cluster generates a list of single cluster words, then a list of multiple cluster words, and then applies a cleanup. To support these list building techniques an ignore words list (“Ignore Words List”) is employed where specific words such as “to”, “and”, “the”, “a” etc are maintained and are therefore not used in the list building technique. As those skilled in the art may imagine, a provision exists to add ignore words which may be industry specific or the like.

In the practice of this cluster method we do the following.
For each search which is the subject of one search string and which may generate a plurality of different url responses, those responses typically including a short title, a brief description and the actual url address itself:
   For each Search Result (“Search Result”) which corresponds to a single set of data associated with a single url, and which set of data supplied by the Search Engine comprises title text (“Title”), description text (“Description”), and url text (“URL):
      i. Break down the Search Result Title and Search Result Description into a list of words (“List of Words”).
      ii. Create a new list, called the cluster candidates list (“Cluster Candidate List”), by adding each word to the Cluster Candidate List and the unique address of each word relative to the List of Words.
      iii. Alphabetically sort the Cluster Candidate List
   In processing single words (“Processing Single Words”)
      1. For each Word (“Word”) in the Cluster Candidate List that appears more then once,
         a. Add each instance of a Word to a newly created cluster list entry (“Cluster List Entry”) where each Cluster List Entry contains the following three things:
         i. the Word,
         ii. the unique address of each occurrence of the Word in the List of Words, and
         iii. a frequency count associated with the number of times that the Word appeared in the Cluster Candidate List.
      2. Add each Cluster List Entry to a new list, the cluster list, (“Cluster List”)
   In processing multiple words
      1. The first step is to build a total of n separate n-word (“N-Word”) lists where n ranges between 2 and the highest desired number of contiguous words in a cluster. In an embodiment of the present invention cluster lengths that ranged from 2 to 6 yielded acceptable results. Relevancy of these multiple word clusters depended on the subject matter searched where general searches favoured a limit of 2 or 3 words and more specific searches favoured 4 to 6 words.
      2. Build those n-word lists by examining each entry in the Cluster List together with the immediately preceding contiguous word. The immediately preceding contiguous word is located by using the address information for each entry in the Cluster List, together with the List of Words.
         a. After the N-Word lists are compiled, repeat the Processing Single Words steps treating each multiple word n-word entry as a single cluster.
   Cleaning up single and multiple words
      i. Using the Ignore Words List remove any single ignore words from the Cluster List
      ii. Using the Cluster List create a new list, use cluster list, (“Use Cluster List”) using the top 15 frequency scoring entries.
      iii. Using each N-Word List, create a new list, use n-word list, (“Use N-Word List”) using the top 15 frequency scoring entries.
      iv. For each Use N-Word List
         1. Remove any entries where they do not contain single words from the Use (N−1) Word List
         2. Remove any entries where the unique frequency count of the multi-word is at least 80% of the unique frequency count of the single word
         3. IF both 1 and 2 from v. above are not satisfied, that is they do not cause the removal of the entry, then remove the single word from the Use (N−1) Word List
      v. Remove any entries of the search terms or subsets of it from each of the Use (N−1) Word List
      vi. Remove any entries where a multiple word list ends with a word from the Ignore Word List
      vii. Remove any entries where a single or multiple word entry is a plural of the singular form and adjust the frequency count. viii. From the remaining words in the Use (N−1) Word List, take the 4 most frequent multi-word words (if available), complete the list (up to 10 items) from the Use Cluster List.

An alternative embodiment of Clustering uses either the Pre-Defined Words or cluster Themes or both as additional search terms or which are combined together with the supplied search term(s). These combined search terms are used to bring back a plurality of additional results which are used to help augment the specific selection. In this way the scope of the search could be expanded to include a wider body of results in a very easy way for the searcher. In practice this might be accomplished with a search query like: search term(s) Pre-Defined Word1 OR Pre-Defined Word2 OR . . . OR Pre-Defined WordN. In an implementation of this embodiment the number of results per combined search term was selected to be limited to 200.

The results of the Clustering Analysis 208 are then used in the final iterations defining the Firm 201 into the five Dimensions. Of particular note here is the awareness of the expert analysts of any risk areas brought to light either from the results of the Cluster Analysis 208 or by experience of the experts—or both. These risks are considered by the expert analysts and a weighting factor is then associated, by the expert analysts, with each aspect of the Dimension activity involved.

It is appreciated that the exemplary Cluster Analysis 208 embodiments described above are merely illustrative of some preferred cluster analysis methods. This clustering description does not limit the implementation of the herein described clustering approach and method, constraining it to have all of the elements and steps described above, as the inventive concepts described herein may be implemented in various clustering environments using various approaches and steps.

Thus the end result of performing one or more iterations of Relationship Analysis 207, then followed by one or more iterations of considering the results of the Cluster Analysis 208, is that for each of the five Dimensions there are one or more Metric 210, 211 . . . 212 aspects defined by the following: (1) Dimension (2) metric aspect name, (3) brief aspect description, (3) aspect value in dollars, and (4) aspect forward looking weighting (ranging from 0.00 to 1.00). This forward looking rating projects the degree of belief in success or lack of risk in realizing its forward value. Thus a weighting on 1.0 would indicate zero risk and a belief of assured success and a weighting of zero would indicate no chance of success.

The various Metrics 210, 211, through 212 are then combined or synthesized 209 for each Dimension to create an economic model for that Dimension. These models combined for each Dimension produce an economic value for each Dimension as well as the metrics within it. Models are discussed in more detail below.

The various values are then aggregated 213 for the five Dimension to produce a valuation for the Firm 201. The weighting probabilities assigned earlier by the experts may be mathematically applied on a per Dimension basis to determine the overall mathematical range, low and high, around each dimension. This may be likewise used in describing a range around the valuation of the Firm 102.

Legend 214 shows the definition of representations used in FIG. 1 and also shows two different types of information. The solid line information flow between the Firm 201 and the Company 202 occurs at the commencement of the valuation effort. Periodically, however, the Firm 201 updates the Company 202 with all the different type of information. Based on the nature, area, and quantity, as well as the time elapsed since the original evaluation, the Company 202 will decided whether to update the value by updating the Metrics or whether a new Relationship Analysis 207 and or Cluster Analysis 208 need to be revised.

One of the preferred embodiments of the present invention involves a subsequent step of normalizing the Value of the Dimensions to recalculated proforma values for Dimensions 2 through 5. They way these proforma values are arrived at are as follows.

First, we examine data from past valuations, for example Venture Capital valuations in a particular industry or area. Since this is a past event we know for sure what the first Dimension, Financial Information, is.

We can then use the Venture Capital valuation and the first Dimension, Financial Information, to determine the collective value of Dimensions 2 through 5 as they are the VC valuation less the first Dimension Financial Information value.

Next we use expert opinions (several independent expert opinions for each firm) to assign percentages to the other four dimensions. Given all the specifics of each individual firm, how would the experts suggest that percentage values might be apportioned, percentage wise, to the four different dimensions. The data on these VC funded firms may be purchased from Chrunchbase or Pitchbook.

This yields a dollar value and hence percentage for each of the five dimensions. Repeat this for a sufficient number of firms (perhaps 20 to 100) in the same industry area and it is then possible to use this data to produce a model of what the relative values of Dimensions 2 through 5 are given a Dimension 1 value. These percentages mat then be used to normalize Dimensions 2 through 5.

This set of proforma values then becomes a check and balance on the values for the Dimensions described about. In this embodiment of the present invention the new information independently derived created from the Venture Capital data can be either considered by another iteration of expert analysis, or can be programmatically normalized as a final step in a valuation process. Element 213 in FIG. 2 shows this programmatic implementation as this element is shown in the figure as a subsystem. Alternatively, as discussed above in the previous embodiment it may be implemented outside a computer system.

The exact model(s) used above in element 209 were not discussed in detail. Those skilled in the art will recognize that there are many useful and potential models which may be used to accommodate this data. The present invention does not rely on the introduction or use of a specific model. The inventors do, however, have a preferred embodiment of a modeling approach.

The reference above by Dzyuma, “Real Options Compared to Traditional Company Valuation Methods: Possibilities and Constraints in their Use” includes “the most important and useful English language publications” regarding Real Options Valuations. One of the preferred embodiments is the use of a Real Options Valuation model because as the reference states, “the area of real options application are usually the company intangible assets.” Real Options Valuation modeling accommodates multiple intangible assets and is a good fit for this decentralized valuation approach.

In summary, then, relevant financial and other data is collected from the Firm 201 to be evaluated, and given to the Company 202 performing the evaluation—which adds its own relevant data as well. The Company then uses experts to conduct both a Relationship Analysis 207 and a Cluster Analysis 208. The results of iterations of these analysis steps are then summarized in Metric definitions 210 through 212 for each Dimension. These Metrics are then modeled to produce the final valuations and then aggregated 213. They may be aggregated with or without a value range.

Abstracting these steps to a higher level, one of the preferred embodiments of the present invention is the data collection 203 thru 206 and analysis 207 208 regarding the Firm, establishing the results, with expert help, of this analysis into a set of decentralized Metrics 210 thru 212, and then running Real Option Valuation models across these different Metrics thereby establishing a value for each Dimension. Then aggregating the Dimension values into a final Finn 201 valuation.

Those skilled in the art will recognize that the elements presented in FIG. 1 could be implemented in several different ways. Nothing in this specification should be understood to limit this invention to a specific computer system implementation and the system shown in FIG. 1 is an exemplary system.

Nothing in this specification should be understood to limit this invention to merely a specific type of company or industry. Indeed this approach could be applied to many different kinds of companies or firms.

In summary, the present invention presents a system and method to help facilitate business valuations using a mix of expert assistance, cluster analysis, financial modeling, and computer technology. This is approach accommodates companies seeking additional capitalization, includes valuing intangible assets, and integrates current data from competitors and current information which may have an impact to the firm under evaluation. This approach can be periodically updated in a relatively easy manner.

1) A method for facilitating business valuations comprising the steps of:
a) Providing, from the firm being evaluated to the evaluating company, all relevant financial data and information, all product and or service data and information, and other related data, URLs and information;
b) engaging and or locating and engaging, by said evaluation company, one or more persons of expertise related to the industry or type of firm of said firm;
c) gathering, by said evaluation company, any additional relevant data and information not provided by said firm under evaluation;
d) conducting, by said evaluation company, a relationship analysis of all relevant said data and information and in so doing dividing and classifying all the value of the firm into the five value dimensions;
e) iterating the relationship analysis as necessary to resolve the value of the firm into the five value dimensions;
f) using related data, URLs, and information provided by the firm together with similar related material gathered by the evaluating company as source material for a cluster analysis;
g) running a cluster analysis to generate different themes or ideas associated with said firm and or the industry of said firm;
h) conducting an expert review of the clustering analysis to determine any new sources of value or any newly identified, heightened, or explained risks;
i) synthesizing all analysis results into separate metrics;
j) modeling, for each of the five firm Dimensions, all of the Metrics into a financial value; and
k) aggregating the said Dimension values into a final value for the firm.

2) Claim 1 including the steps of:
a) applying the individual weighting factors to the individual metric values and aggregating a weighted value for each metric; and
b) aggregating said weighted dimension values into a final value for said firm.

3) Claim 1 including the steps of:
a) Conducting steps a) thru k) periodically to establish a new value for the firm.

4) Claim 2 including the steps of:
a) Conducting steps a) thru k) and then claim 2 steps a) and b) periodically to establish a new value for the firm.

5) A non-transitory computer readable medium having stored thereon computer executable instructions instructive of a method for facilitating business valuations and connected to the Internet comprising the steps of:
a) Providing, from the firm being evaluated to the evaluating company transferred via computer readable media or via network connection, or equivalent method of transfer, all relevant financial data and information, all product and or service data and information, and other related data, URLs and information;
b) engaging and or locating and engaging, by said evaluation company, one or more persons of expertise related to the industry or type of firm of said firm;
c) gathering, by said evaluation company, on computer readable media, any additional relevant data and information not provided by said firm under evaluation;
d) conducting, by said evaluation company, a relationship analysis of all relevant said data and information, using expert help, and in so doing dividing and classifying all the value of the firm into the five value dimensions;
e) iterating the relationship analysis as necessary to resolve the value of the firm into the five value dimensions;
f) using related data, URLs, and information provided by the firm together with similar related material gathered by the evaluating company as source material for a cluster analysis conducted via said computer;
g) running a cluster analysis via said computer to generate different themes or ideas associated with said firm and or the industry of said firm;
h) conducting an expert review of the clustering analysis to determine any new sources of value or any newly identified, heightened, or explained risks;
i) synthesizing all analysis results into separate metrics;
j) modeling, for each of the five firm Dimensions, all of the Metrics into a financial value; and
k) aggregating the said Dimension values into a final value for the firm.
